(19) United States
(12) Patent Application Publication
(10) Pub. No.: US 2024/0232971 A1
(43) Pub. Date: Jul. 11, 2024

(54) FASHION DESIGN ASSISTANT TOOL AND ASSOCIATED METHODS

(71) Applicant: Toile Designs LLC d/b/a DIY Fashion Design, Aspen, CO (US)

(72) Inventor: Mirjam J. Rosner, Aspen, CO (US)

(21) Appl. No.: 18/410,821

(22) Filed: Jan. 11, 2024

Related U.S. Application Data
(60) Provisional application No. 63/479,450, filed on Jan. 11, 2023.

(51) Int. Cl. G06Q 30/0601

(52) U.S. Cl. CPC G06Q 30/0621; G06Q 30/0643

(57) ABSTRACT

A fashion design system includes a fashion design assistant tool, implemented in part by an app running on a smartphone, provides resources, tools, skills, and expertise to allow a user to both (a) design and (b) make their own clothes. A computer server may interact with multiple pattern suppliers to receive pattern data and interacts with at least one fabric supplier to receive fabric data, storing the pattern data and the fabric data in a database. The fashion design assistant tool allows the user to select pattern data for a garment from any of the multiple pattern suppliers and fabric data of a suitable fabric for the garment from the at least one fabric supplier. The fashion design assistant tool displays a representation of the garment made from the fabric on a display of the client device and facilitates purchase of the pattern data and the fabric.

### RELATED APPLICATION

This application claims priority to U.S. Patent Application Ser. No. 63/479,450, filed Jan. 11, 2023, which is incorporated herein by reference in its entirety.

### BACKGROUND

For an individual to make their own clothes, or to make clothes for others at home, requires skill and access to resources that are diversely scattered. Accordingly, the individual is easily discouraged.

### SUMMARY

One aspect of the present embodiments includes the realization that designing and making clothes at home requires many skills that are not readily assembled and available in one place. Advantageously, a fashion design assistant app running on a client device (e.g., a smartphone, a tablet computer, etc.) provides tools, skills, expertise, and resources to allow a user to both (a) design and (b) make their own clothes.

In certain embodiments, the techniques described herein relate to a fashion design assistant method, including: receiving, at a client device, a pattern selection identifying pattern data for a garment; receiving, at the client device, a fabric selection identifying fabric data for a fabric; generating, based on the pattern selection and the fabric selection, a representation of the garment made from the fabric; and displaying the representation of the garment on a display of the client device.

In certain embodiments, the techniques described herein relate to a non-transitory computer-readable medium containing machine-readable instructions for causing a computer to: receive, at a client device, a pattern selection identifying pattern data for a garment; receive, at the client device, a fabric selection identifying fabric data for a fabric; generate, based on the pattern selection and the fabric selection, a representation of the garment made from the fabric; and display the representation of the garment on a display of the client device.

In certain embodiments, the techniques described herein relate to a fashion design system, including: a computer server, having: a pattern interface including machine-readable instructions stored on non-transitory computer-readable medium that, when executed by a first processor of the computer server, causes the computer server to interact with a pattern supplier to receive pattern data; a fabric interface including machine-readable instructions stored on the non-transitory computer-readable medium that, when executed by the first processor of the computer server, causes the computer server to interact with a fabric supplier to receive fabric data; and a database for storing the pattern data and the fabric data; and a fashion design assistant tool including machine-readable instructions stored on non-transitory computer-readable medium that, when executed by a second processor of a client device, cause the client device to: receive a pattern selection identifying the pattern data for a garment; receive a fabric selection identifying the fabric data for a fabric; generate, based on the pattern selection and the fabric selection, a representation of the garment made from the fabric; and display the representation of the garment on a display of the client device.

### BRIEF DESCRIPTION OF THE FIGURES

FIG. 1 is a block diagram illustrating one example fashion design system including a fashion design assistant tool that provides multiple resources to allow a user to design and make their own clothes, in embodiments.

FIG. 2 is a block diagram illustrating client device and server of FIG. 1 in further example detail, in embodiments.

FIG. 3 is a block diagram illustrating the fashion design assistant tool of FIG. 1 in further example detail, in embodiments.

FIG. 4A is a schematic illustrating a pattern representation, corresponding to a selected pattern data, formed on a mannequin, in embodiments.

FIG. 4B is a schematic illustrating the pattern representation of FIG. 4A formed on an image of a person, in embodiments.

FIG. 5 is a screenshot from the fashion design assistant tool running on client device of FIG. 1 illustrating purchase of pattern design from pattern supplier by user, in embodiments.

FIGS. 6A, 6B, and 6C show screen shots that illustrate example steps implemented by fashion design assistant tool to capture information of a new fabric, in embodiments.

FIG. 7 is a flowchart illustrating one example fashion design assistant tool method, in embodiments.

FIG. 8 is a block diagram illustrating example detail of the pattern data and the fabric data of FIGS. 1 and 2, in embodiments.

FIG. 9 is a screenshot of the pattern interface of the server of FIGS. 1 and 2, illustrating set up of the fashion design system for multi-vendor use, in embodiments.

FIG. 10 is a screenshot of the pattern interface of the server of FIGS. 1 and 2, illustrating step-by-step pattern-uploading implemented by the fashion design system that allows any pattern supplier to easily upload pattern data for use by the system, in embodiments.

FIG. 11 is a screenshot of the pattern interface of the server of FIGS. 1 and 2, illustrating the pattern supplier being prompted to provide important sewing pattern information for the pattern data, for use by the fashion design assistant tool, in embodiments.

FIG. 12 is a screenshot of the fashion design assistant tool of FIG. 1, inviting a novice DIY sewer to create an account to be able to save, collect, and see a design they may make by combining sewing patterns and fabrics in their personal virtual design studio, in embodiments.

FIG. 13 is a screenshot illustrating how the fashion design assistant tool of FIG. 1 provides a visual of the user's design when they combine a sewing pattern with a fabric, in embodiments.

FIG. 14 is a screenshot illustrating how the fashion design assistant tool of FIG. 1 allows the user to collect and save fabrics and patterns, in embodiments.

FIG. 15 is a screenshot illustrating how the fashion design assistant tool of FIG. 1 allows the user to access to a variety of sewing patterns, in embodiments.

FIG. 16 is a screenshot illustrating how the fashion design assistant tool of FIG. 1 allows the user to take a picture, or select one from their photo gallery, to save in this section of fashion design assistant tool, in embodiments.

FIG. 17 is a screenshot illustrating how the fashion design assistant tool of FIG. 1 integrates all elements of a design together to provide a visual of a finished garment based on the pattern data and the fabric data selected by the user, in embodiments.

FIG. 18 is a screenshot illustrating how the fashion design assistant tool of FIG. 1 provides a community minded space where the user has access to useful information, in embodiments.

### DETAILED DESCRIPTION OF THE EMBODIMENTS

There is no easily accessible single solution that allows a user to design and make their own clothes. Particularly, there is no single solution that provides instructions, guidance, advice, a source of materials and tools (e.g., patterns, fabrics, needles, threads, etc.) combined with a fashion design assistant tool that allows the user to design, source materials, and output needed patterns to make their own clothes. By combining all this functionality into an easy-to-use solution, the fashion design assistant tool provides new and existing DIY sewing fashionistas a complete experience to purchase, design, and assemble their own clothes. Particularly, the fashion design assistant tool provides a visualization of a finished product during the design process and then provides easy access to useful information and material sources to make the clothes. Advantageously, the fashion design assistant tool fills a gap between designing and making garments on a mobile platform that is usable anywhere by anyone.

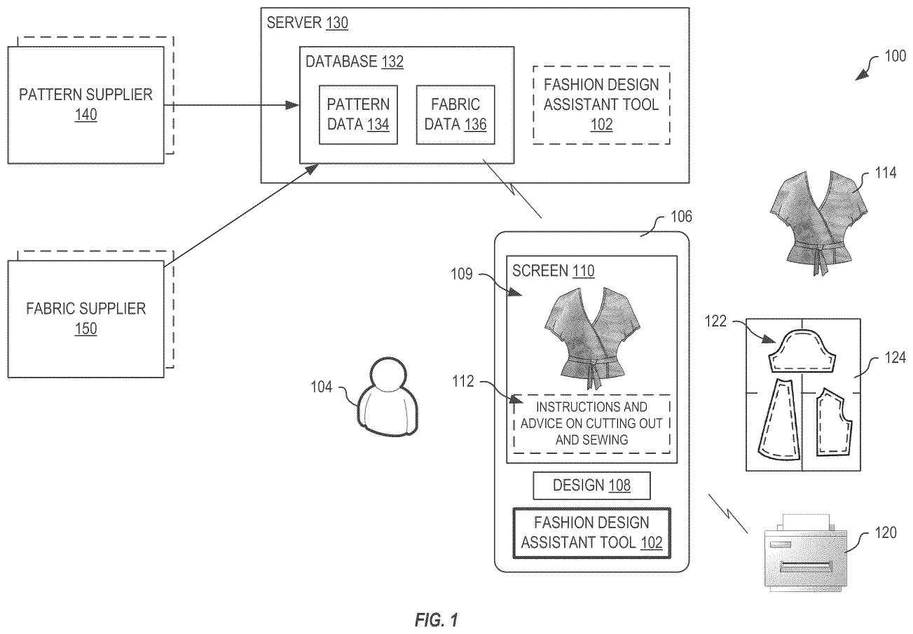

FIG. 1 is a block diagram illustrating one example fashion design system 100 including a fashion design assistant tool 102 that provides multiple resources (e.g., tools, skills, and expertise) to allow a user 104 to design and make their own clothes. Fashion design assistant tool 102 is an app that is downloadable onto a client device 106 (e.g., a smartphone, a tablet, etc.).

System 100 also includes a server 130 with a database 132. Server 130 may represent one or more of an online computer server, a network of computer servers, a cloud-based server, and a cloud-based service (e.g., Amazon Web Services, Google Cloud, etc.). Server 130 is accessible via the Internet for example. Server 130 may include one or more application programmer interfaces (APIs) that allow a pattern supplier 140 to upload at least one pattern data 134 to database 132. Pattern supplier 140 is for example a vendor of digital patterns that may be printed and/or plotted onto paper to form a pattern to that may be used by a DIY sewing fashionistas (e.g., user 104) make a garment 114. Server 130 may include one or more APIs that allow a fabric supplier 150 to upload at least one fabric data 136 to database 132. Fabric supplier 150 is for example a vendor of fabrics, and fabric data 136 include information and an image of a particular fabric.

In one example of operation, system 100 partners with at least one pattern supplier 140 and/or at least one fabric supplier 150 whereby pattern data 134 and/or fabric data 136 is displayed for selection within fashion design assistant tool 102. Further, fashion design assistant tool 102 may facilitate interaction with at least one pattern supplier 140 and/or fabric supplier 150 to allow user 104 to purchase one or more pattern data 134 and/or fabrics fashion via design assistant tool 102.

Fashion design assistant tool 102, based on interaction with user 104, retrieves pattern data 134 (e.g., a purchased digital pattern for garment 114) and fabric data 136 from database 132 and interactively allows user 104 to create a design 108 based on both pattern data 134 and fabric data 136, whereby design 108 is displayed as a design representation 109 of garment 114 based on pattern data 134 and using a fabric defined by fabric data 136 is displayed on screen 110 of client device 106. Advantageously, user 104 is able to view design representation 109 of garment 114 made using the selected fabric prior to actually making garment 114. In one example of operation, fashion design assistant tool 102 graphically processes an image from pattern data 134 and an image from fabric data 136 to form design representation 109. In one embodiment, pattern data 134 includes an image with a line representation of garment 114 (e.g., the garment corresponding to the pattern) where an inside of the line representation is transparent to show parts of an image of a selected fabric and thereby form design representation 109. In other embodiments, pattern data 134 includes a 3D model of garment 114 whereby fashion design assistant tool 102 wraps parts of the image of a selected fabric around the 3D model to form design representation 109.

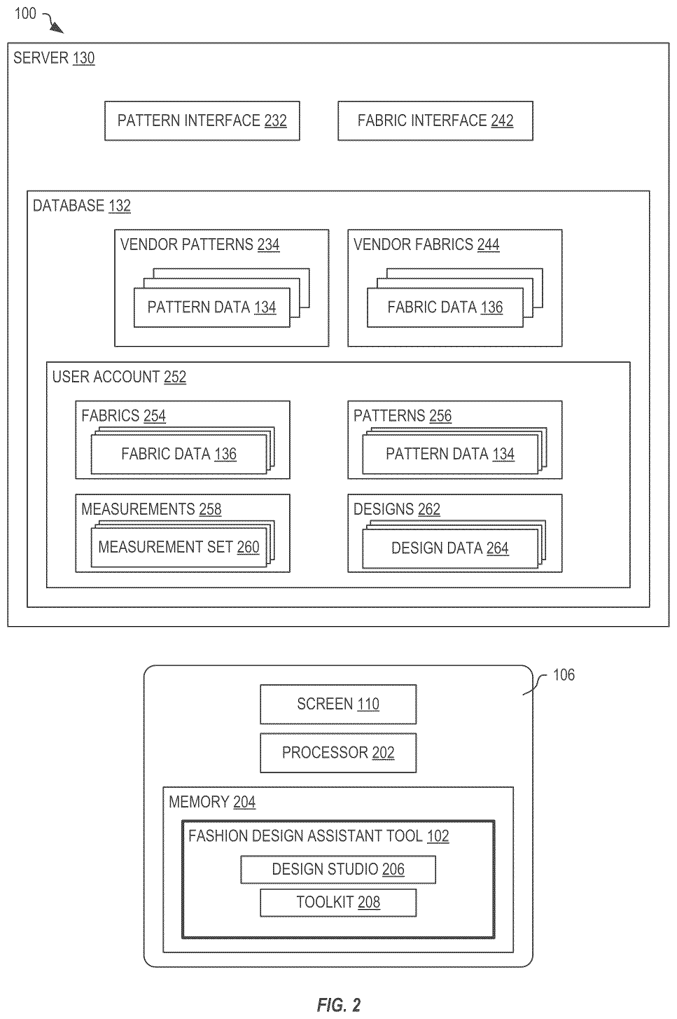

Fashion design assistant tool 102 allows user 104 to record a set of measurements and determines a size of garment 114. Fashion design assistant tool 102 may then output corresponding pattern data 134 to a local printer 120 (or plotter) as a pattern outline 122 that is printed onto one or more sheets of paper 124. Fashion design assistant tool 102 may also provide instructions and advice in a notification 112 for making garment 114. In certain embodiments, system 100 may be affiliated with one or more vendors and may recommend certain items over others. Throughout the user's progress of designing and making of garment 114, fashion design assistant tool 102 displays instructions and advice in notification 112 such that user 104 may learn, receive advice, and receive tips. Further, fashion design assistant tool 102 provides a toolkit (see toolkit 208, FIG. 2) that support user 104 during the design and making process.

FIG. 2 is a block diagram illustrating client device 106 and server 130 of FIG. 1 in further example detail. Server 130 includes a pattern interface 232 that allows pattern supplier 140 to upload pattern data 134 for inclusion within a vendor patterns 234 portion of database 132 that stores pattern data 134 that user 104 may review and purchase. Pattern data 134 may include one or more technical drawings that form the sewing pattern, a seam allowance, an expertise level, units of measure (e.g., metric, or imperial), written instructions, whether it needs a lining and if so, how much.

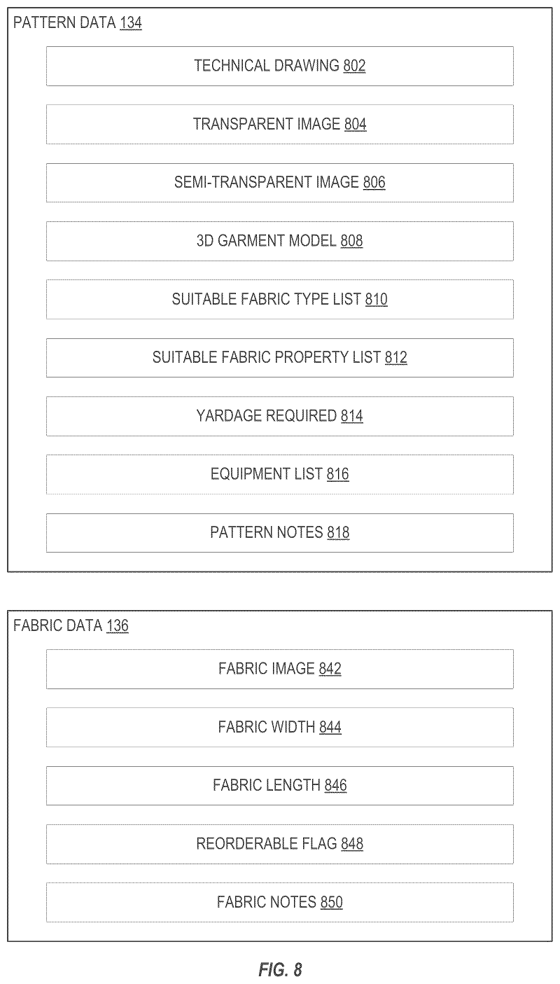

FIG. 8 is a block diagram illustrating example detail of pattern data 134 and fabric data 136. Pattern data 134 may include a technical drawing 802, a transparent image 804 formed as a transparent line drawing, a semi-transparent image 806 formed as a semi-transparent line drawing, a 3D garment model 808, a suitable fabric type list 810, a suitable fabric priority list 812, a yardage required 814, and an equipment list 816. Fabric data 136 may include a fabric image 842, a fabric width 844, a fabric length 846, a reorderable flag 848, and fabric notes 850. FIGS. 1, 2 and 8 are best viewed together with the following description.

To make pattern data 134 usable by fashion design assistant tool 102, pattern interface 232 may require pattern supplier 140 to provide information for each of these field in a desired data format. In certain embodiments, pattern interface 232 automatically process received pattern information from pattern supplier 140 to generate the correct data format for pattern data 134. In certain embodiments, pattern interface 232 includes at least one API that allows pattern supplier 140 to access database 132 to add and/or remove pattern data 134 without user intervention.

In one example of operation, pattern supplier 140 uploads, via pattern interface 232, at least one technical drawing 802, transparent image 804, semi-transparent image 806, 3d garment model 808, suitable fabric type list 810, suitable fabric property list 812, yardage required 814, equipment list 816, and pattern notes 818 including other relevant information for the sewing pattern, such as tips and advice. In certain embodiments, pattern interface 232 processes the technical drawing to generate transparent image 804, and semi-transparent image 806, wherein pattern supplier 140 does not generate or upload transparent image 804 or semi-transparent image 806. Pattern supplier 140 may also define one or more suitable fabric types in suitable fabric type list 810 and/or may define one or more suitable fabric properties in fabric notes 850, such as a fabric firmness, how the fabric flows, whether it is light-weight, soft-hand, etc.

Appendix A includes example screenshots of pattern interface 232 illustrating how pattern supplier 140 interacts with server 130 in embodiments.

Server 130 includes a fabric interface 242 that allows fabric supplier 150 to upload fabric data 136 for inclusion within a vendor fabrics 244 portion of database 132 that stores fabric data 136 that user 104 may review and use in designs and optionally purchase. Fabric data 136 may include a fabric type (e.g., a cotton twill, or a poly viscose etc.), a fabric kind, a fabric width (e.g., fifty-six inches), whether or not it is reorderable, an image of the fabric (e.g., correctly sized to be usable by fashion design assistant tool 102), and fabric notes 850 on the fabric. For example, fabric notes 850 may describe characteristics and/or uses, tips, and advice of use of the fabric that are not stored in other fields of fabric data 136. For example, fabric notes 850 may include one or more of weight, momme/thread count, ends per inch (e.p.i), picks per inch (p.p.i), firmness/softness, etc. Fabric data 136 may include other information without departing from the scope hereof. Fabric interface 242 may require fabric supplier 150 provide fabric information as a data structure corresponding to fabric data 136. In certain embodiments, fabric interface 242 may automatically process fabric information received from fabric supplier 150 in other formats to generate fabric data 136. In certain embodiments, fabric interface 242 includes at least one API that allows fabric supplier 150 to access database 132 to add and/or remove fabric data 136 without user intervention. For example, fabric supplier 150 may access database 132 to update fabric data 136 to indicate availability of the fabric.

Fashion design assistant tool 102 is stored in memory 204 (e.g., a non-transitory computer-readable medium) and includes machine-readable instructions (e.g., software) that are executable by a processor 202 of client device 106 to implement functionality of fashion design assistant tool 102 as described herein. Fashion design assistant tool 102 includes a design studio 206 that allows user 104 to interactively create design 108, which is stores as design data 264 within a designs 262 portion of database 132 of server 130. Fashion design assistant tool 102 also includes a toolkit 208 that makes multiple resources available to user 104, such as allowing user 104 to store sets of measurements (e.g., their own measurements, or measurements of other people) that may be used when determining a size for pattern data 134 and/or a quantity of fabric based on fabric data 136. The toolkit may also provide links to suppliers of relevant tools such as sewing needles, sewing machines, scissors etc. Advantageously, toolkit 208 provides these resources within fashion design assistant tool 102 such that they are readily available to user 104.

Where a selected pattern data 134 defines a suitable fabric type in which to make the corresponding garment 114, design studio 206 may advise user 104 when inappropriate fabric data 136 is paired with pattern data 134 in design 108. For example, where user 104 creates design 108 using pattern data 134 that indicates a two-way stretch is preferred and then selects fabric data 136 that defines a non-stretch fabric, fashion design assistant tool 102 generates notification 112 to indicate that a two-way stretch fabric is preferred for pattern data 134. Fashion design assistant tool 102 may also generate notification 112 to indicate when the selected fabric is unsuitable for use with pattern data 134 for other reasons. For example, where fabric width 844 is insufficient to make garment 114, or when reorderable flag 848 indicates that the selected fabric is not orderable, fashion design assistant tool 102 generates notification 112 to indicate that it would be better to select a different fabric to make garment 114. Advantageously, fashion design assistant tool 102 helps user 104 avoid mistakes prior to making garment 114. Further, fashion design assistant tool 102 may make fabric recommendations by indicating which fabric data 136, within fabrics 254 of user account 252 and/or vendor fabrics 244, are suitable for use with pattern data 134. In one example of operation, after the user has selected a pattern, design studio 206 may generate notification 112 indicating that the selected pattern recommends a woven or a knit type of fabric, or a non-woven type of fabric. Notification 112 may also indicate a suitable machine needle type and size based on equipment list 816. Notification 112 may also indicate a suitable fabric kind, such as a cotton twill, or a poly viscose, etc. Notification 112 may also indicate an estimated yardage of fabric to purchase as determined by design studio 206 based on measurement set 260 associated with the selected pattern data 134 and based on a fabric width 844 (e.g., see FIG. 8) of the selected fabric data 136. Design studio 206 may also generate notification 112 to indicate when the selected fabric defined by fabric data 136 is unsuitable for use with pattern data 134. Design studio 206 may also determine or select the required yardage of the selected fabric based on yardage requirement 814, fabric width 844, and the user's size as defined by measurement set 260. Design studio 206 may also generate notification 112 to indicate suitable fabric properties (weight, flow, firm hand, etc.) based on fabric notes 850. In certain embodiments, design studio 206 may generate notification 112 to suggest fabrics suitable for use with the selected pattern. For example, design studio 206 may match fabric data 136 from database 132 with the requirements defined by the selected pattern data 134. Design studio 206 may also generate notification 112 to display a “check-list” of supplies needed to complete garment 114.

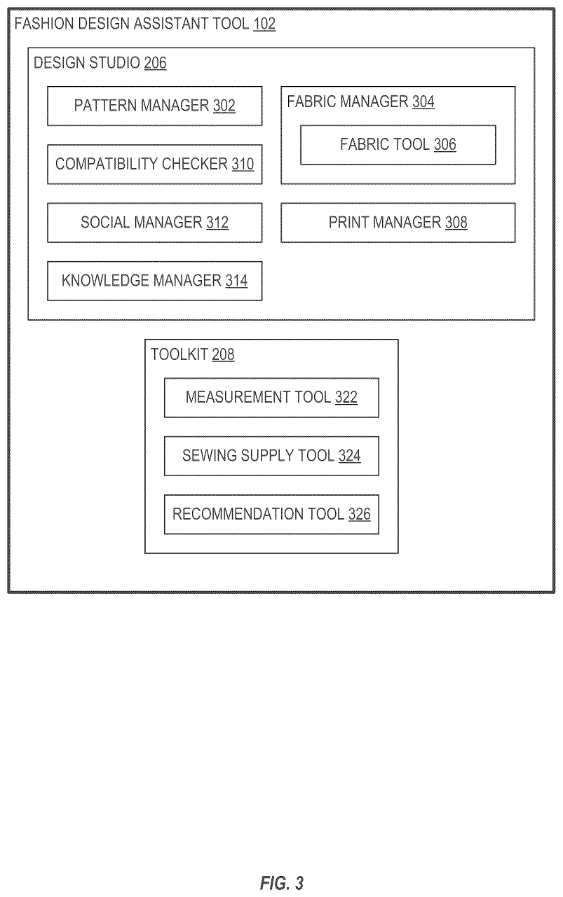

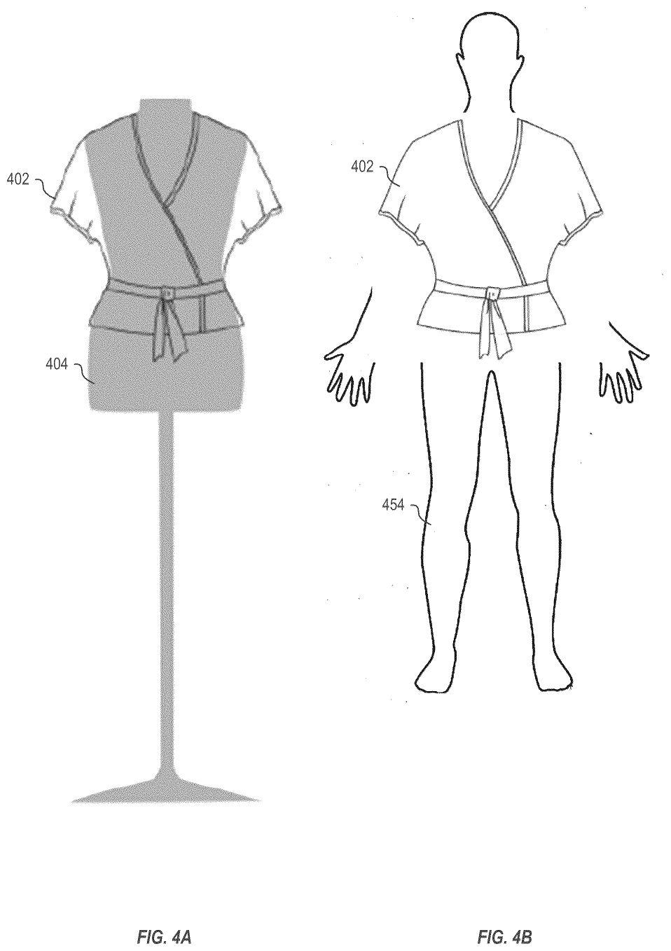

FIG. 3 is a block diagram illustrating fashion design assistant tool 102 of FIG. 1 in further example detail. FIG. 4A is a schematic illustrating a pattern representation 402, corresponding to a selected pattern data 134, formed on a mannequin 404. In certain embodiments, mannequin 404 is statically sized and transparent image 804 and semi-transparent image 806 are match in size thereto such that transparent image 804 and semi-transparent image 806 fit on top of mannequin 404. In other embodiments, design studio 206 dynamically sizes mannequin 404 based on the selected measurement set 260 and/or selected size of the pattern within pattern data 134. Similarly, when mannequin 404 is replaced by the user's image, one or more of the user's image, transparent image 804 and semi-transparent image 806 are dynamically sized to match such that the user is able to see themselves in garment 114. Similarly, 3D garment model 808 may be dynamically sized based on one or more of measurement set 260 and/or the image of the user (or recipient of the garment). In certain embodiments, image “warping” techniques may be used to size images to fit one another.

Pattern representation 402 is similar to design representation 109 but does not include a representation of a fabric. FIGS. 2, 3 and 4A are best viewed together with the following description.

Design studio 206 includes a pattern manager 302 that maintains patterns 256 within user account 252. Pattern manager 302 provides multiple screens that allow user 104 to interactively review pattern data 134 within either of vendor patterns 234 or patterns 256 of user account 252. For example, pattern manager 302 allows user 104 to select any of pattern data 134 from patterns 256, since they have already been acquired by user 104. Pattern manager 302 also allows user 104 interactively search within vendor patterns 234 to find a new pattern that may be purchased by pattern supplier 140. In certain embodiments, where user 104 has selected or defined measurement set 260, pattern manager 302 may provide a warning (e.g., via notification 112) when the pattern data selected for purchase is not of the correct size based on measurement set 260.

In certain embodiments, pattern manager 302 groups available pattern data 134 according to one or more of vendor, garment type (e.g., tops, bottoms, dresses, etc.), skill level (e.g., novice, moderate, accomplished), material type, and so on. Advantageously, pattern manager 302 allows user 104 to easily find and purchase a suitable pattern for their needs.

Design studio 206 also include a fabric manager 304 that maintains fabrics 254 of user account 252. Fabric manager 304 implements a fabric tool 306 that allows user 104 to capture fabric data 136 on the fly. For example, when user 104 visits a fabric store, user 104 uses fabric tool 306 to capture fabric data 136 of fabrics for sale in the store. For example, fabric tool 306 provides instructions for user 104 to capture, using a camera of client device 106 with a one-times magnification lens, an image of the fabric that may be used by design studio 206. Fabric tool 306 may then prompt user 104 to input characteristics (e.g., fabric type, fabric kind, width, cost, etc.) of the photographed fabric that are stored together as fabric data 136. In certain embodiments, where enabled by functionality of client device 106, fabric tool 306 controls client device 106 to measure a distance between client device 106 and the fabric being imaged and provide instructions to the user via screen 110 to move closer or further away from the fabric to ensure fabric image 842 has a representative scale for the fabric. For example, where five feet is a preferred distance to capture fabric image 842, fabric tool 306 instructs the user to move the camera closer to the fabric when the measured distance is greater than five feet, and instructs the user to move the camera away from the fabric when the measured distance is less than five feet. Advantageously, fabric tool 306 ensure that fabric image 842 allows design studio 206 to show a realistic representation of garment 114 made from the fabric. In another example of operation, fabric manager 304 allows user 104 to search and find fabrics on the Internet. Fabric manager 304 also allows user 104 to search vendor fabrics 244 to find a new fabric sold by fabric supplier 150.

Design studio 206 also includes a print manager 308 that provides instructions for user 104 to output at least part of pattern data 134 to local printer 120 (or a plotter). In certain embodiments, pattern data 134 includes a print file and/or a plot file representation of technical drawing 802 that may be sent to a printer. In other embodiments, print manager 308 processes technical drawing 802 based on measurement set 206 to generate the print file and/or the plot file for output to a printer, or for sending to a printing service. For certain pattern data 134, output to a printer or plotter may be unnecessary since pattern supplier 140 sends a paper copy of the pattern to the user when purchased.

Design studio 206 also includes a compatibility checker 310 that may be invoked by design studio 206 when user selects fabric data 136 for an already selected pattern data 134 of design 108. For example, when user 104 selects fabric data 136 from vendor fabrics 244, compatibility checker 310 compares requirements of pattern data 134 with characteristics of fabric data 136 to determine whether the fabric would be suitable for making garment 114 according to information within pattern data 134. When compatibility checker 310 detects an incompatibility, compatibility checker 310 generate notification 112 to display the incompatibility to user 104.

Design studio 206 also includes a social manager 312 that allows user 104 to share design 108 with other users. For example, social manager 312 allows user 104 to send one or more images of design 108 to a social media site (e.g., Facebook, Pinterest, etc.), an airdrop recipient, and may allow user 104 to save the one or more images to a folder of client device 106 and/or other networked devices.

Design studio 206 also includes a knowledge manager 314 that includes links to online resources that provide help and advice on sewing and making of garments 114. Advantageously, knowledge manager 314 is easily accessible within design studio 206 and provides instructions, tips, and references that allows user 104 to design and make garment 114 without the need to look elsewhere for information. In one example of operation, knowledge manager 314 presents notification 112 and/or additional screens of information relative to a current function being used by user 104, such presenting design tips when user 104 is creating design 108 and presenting sewing tips after user 104 has output pattern data 134 to local printer 120. That is, knowledge manager 314 follows context of user 104 using fashion design assistant tool 102 to provide relevant information when requested.

Toolkit 208 includes a measurement tool 322, a sewing supply tool 324, and a recommendation tool 326. Measurement tool 322 interacts with user 104 to receive a measurement set 260 defining measurements (e.g., chest, waist, and hips) a person being fitted for garment 114. Measurement tool 322 allows user 104 to name each measurement set 260, which are stored in measurements 258 of user account 252. Measurement tool 322 may also display one or more vendor sizing charts, corresponding to a selected pattern data 134 for example, to allow user 104 to select an appropriate pattern size where pattern supplier 140 has multiple size options.

In certain embodiments, design studio 206 includes one or more predefined images and/or 3D models of persons of various sizes and body types, where instead of capturing an image or 3D model of a person, the use selects an appropriate one of the predefined images or 3D models. Design studio 206 may allow the user to fit an image of the person to the selected predefined image or 3D model. Design studio 206 may automatically scale technical drawings 802 and/or 3D garment model 808 to fit the selected predefined image or 3D model.

In another embodiment, design studio 206 manipulates 3D garment model 808 to simulate movement based on properties of the selected fabric and displays the movement on screen 110. Advantageously, by displaying the movement of garment 114, the user may envision how the selected fabric behaves when made into garment 114.

As shown on FIG. 4A, transparent image 804 from pattern data 134 is overlaid onto mannequin 404 to allow the user to view the pattern during selection. Once the user has selected a fabric, semi-transparent image 806 is filled with part of fabric image 842 to represent a view of garment 114 made from the selected fabric. Other parts of semi-transparent image (e.g., outside the outline of the garment) may be filled with a solid color. In certain embodiments, design studio 206 may use other imaging manipulation techniques to generate the view of garment 114, such as by generating masks, adding, and subtracting masked images, etc.

FIG. 4B is a schematic illustrating pattern representation 402 of FIG. 4A formed on an image 454 of a person. In certain embodiments, measurement tool 322 also allows user 104 to capture or upload an image of the person corresponding to measurement set 260, wherein design studio 206 may display pattern representation 402 on the captured image 454 of the person instead of on mannequin 404. Advantageously, the visual image of the person wearing garment 114 made from the selected fabric may then be shared on social media for example. This provides a valuable solution for the bridal or evening industry.

As described above, fabric tool 306 may instruct the user on capturing an image of a new fabric. Similarly, design studio 206 may instruct the user on capturing an image of a person (e.g., themselves, their daughter, etc.) intended to receive garment 114. For example, design studio 206 may instruct the user to capture the image of the person from a certain distance, using technology of client device 106 to measure the distance. In certain embodiments, design studio 206 may use augmented reality (e.g., graphical overlays on screen 110) to instruct the user on capturing the person in an appropriate pose. In certain embodiments, design studio 206 may use the image of the person to estimate measurement set 260. In another example, design studio 206 may correspond with pattern supplier 140 to determine the correct size of pattern for the person based on a sizing chart.

In certain embodiments, design studio 206 may use 3D model capturing software on client device 106 to capture a 3D model of the person. For example, design studio 206 may instruct the user to capture a video of the person while walking around then, whereby the 3D model capturing software processes the video and generates a 3D model of the person. This 3D model may then be used in place of mannequin 404 to model 3D garment model 808, whereby the fabric textured 3D garment model 808 is displayed as if worn by the 3D model of the person. Advantageously, design studio 206 may generate a “spin-view” of the person wearing garment 114 that allows the user to see what garment looks like from any angle when worn by the person.

Advantageously, where the fabric has a distinguishable design (as opposed to a plane color), by mapping fabric image 842 to 3D garment model 808, the user may interactively move the fabric on 3D garment model 808 to see how placement of the fabric affects appearance of garment 114. In certain embodiments, design studio 206 may “cut” fabric image 842 based on technical drawing 802, and then map the cut portions to 3D garment model 808 to give a more realistic view of garment 114 made from the fabric. In certain embodiments, design studio 206 interacts with the user to position the different parts of the pattern on fabric image 842 such that the placement is aesthetically pleasing for the design of the fabric. Design studio 206 may adjust the yardage required of the fabric based on the placement of the design on 3D garment model 808.

That is, mannequin 404 is replaced by image 454 of the person. For example, where measurement set 260 is of a daughter of user 104, measurement tool 322 (or other components of fashion design assistant tool 102) allows user 104 to capture image 454 of the daughter, and associates image 454 with measurement set 322 such that it may be used by design studio 206 in place of mannequin 404. Accordingly, design 108 may be displayed as if worn by the daughter.

Sewing supply tool 324 provides an interface to one or more vendors of tools that may be used to make garment 114. For example, sewing supply tool 324 may provide one or more links to a vendor's website. In certain embodiments, sewing supply tool 324 uses a skill level of user 104 to select an appropriate set of tools. For example, where user 104 is a novice, sewing supply tool 324 may provide links to sets of tools that a novice may need to buy when starting to make their own garments. In another example, where user 104 is already skilled at making garments, sewing supply tool 324 may provide links to tools that are more specialized.

Recommendation tool 326 may be invoked to recommend combinations of pattern data 134 and fabric data 136. In one example, where a user has selected pattern data 134, recommendation tool 326 may select and display ones of fabric data 136 from fabrics 254 of user account 252 that are suitable for use with pattern data 134. In another example, where user 104 has selected fabric data 136, recommendation tool 326 may select and display ones of pattern data 134 from patterns 256 of user account 252 that are suitable for use with fabric data 136. In another example, recommendation tool 326 receives a promotion from one or both of pattern supplier 140 and/or fabric supplier 150 (or from other sources such as social media), indicating a pattern data 134 and fabric data 136 combination that are being promoted. For example, pattern supplier 140 and fabric supplier 150 (or a third-party affiliate) may offer pattern data 134 and fabric data 136 (e.g., a corresponding quantity of fabric) for a promotional price.

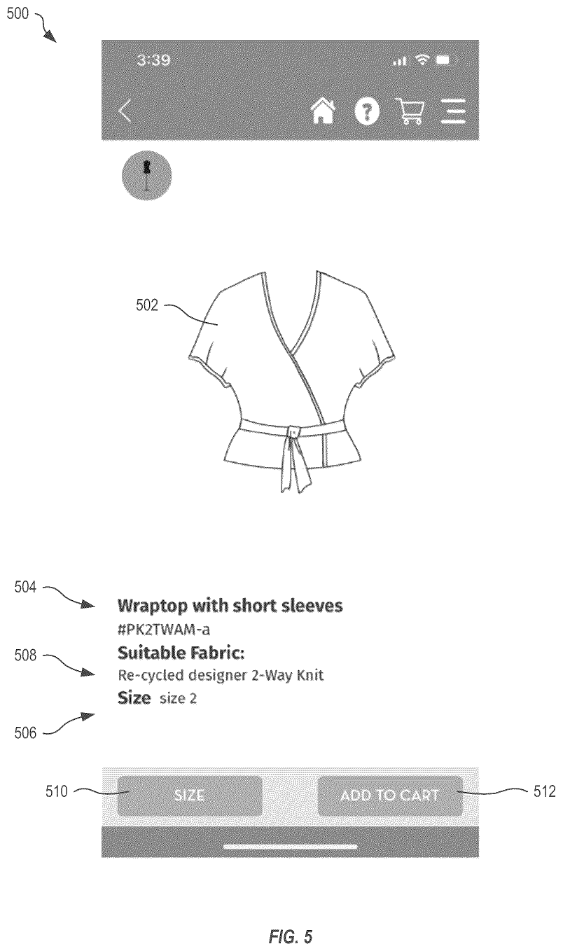

FIG. 5 is a screenshot 500 from fashion design assistant tool 102 running on client device 106 of FIG. 1 illustrating purchase of pattern data 134 from pattern supplier 140 by user 104. Pattern manager 302 displays a pattern representation 502 based on technical drawings of pattern data 134 selected by user 104 on screen 110. Pattern representation 502 is similar to pattern representation 402 of FIGS. 4A and 4B. Pattern data 134 has a displayed name 504 of “Wraptop with short sleeves” in an indicated size 506 of “size 2.” Pattern manager 302 also displays a fabric recommendation 508 “Re-cycled designer 2-way knit” such that user 104. Where the indicated size is incorrect, user 104 may select a size button 510 to select an alternative size offered by pattern supplier 140. User 104 selects a purchase button 512 to add the selected pattern data 134 to their virtual shopping cart. When ready, user 104 may view the shopping cart and complete the purchase.

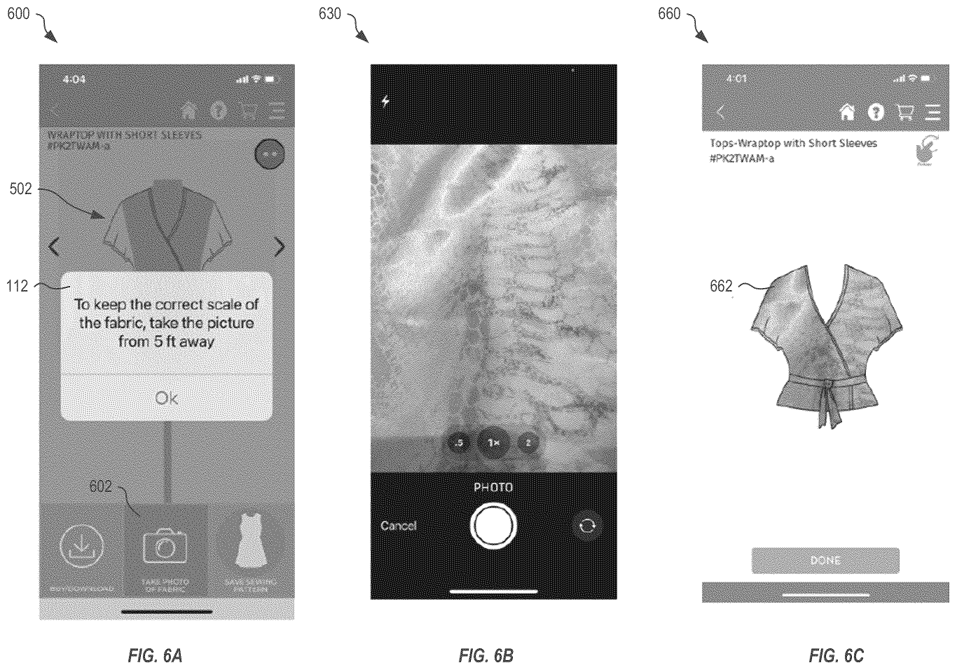

FIGS. 6A, 6B, and 6C show screen shots 600, 630, and 660, respectively, that illustrate example steps implemented by fashion design assistant tool 102 to capture information of a new fabric. FIGS. 2, 6A, 6B, and 6C are best viewed together with the following description.

In one example, user 104 visits a fabric store in search of a suitable fabric to use with pattern data 134 to make garment 114. In another example, user 104 discovers a new fabric while out shopping for other items. Advantageously, fashion design assistant tool 102 allows user 104 to (a) capture and store information of the new fabric for future use, and (b) immediately view a representation of pattern data 134 using the new fabric—prior to purchase of the fabric.

In FIG. 6A, user 104 has selected a “take photo of fabric” button 602 after selecting a saved design data 264, or selecting pattern data 134 from patterns 256, or selecting a new pattern data 134 from vendor patterns 234, that causes representation 502 of pattern data 134 to be displayed on screen 110. In response to selection of button 602, fabric tool 306 displays notification 112 with instructions for capturing an image of the fabric. In FIG. 6B, user 104 is controlling client device 106 as instructed and captures an image of the fabric. Fabric tool 306 then processes the image to form fabric data 136. In certain embodiments, fabric tool 306 interactively requests additional information (e.g., fabric kind, fabric type, width, etc.) of the fabric from user 104 and stores fabric data 136 in fabrics 254. Fashion design assistant tool 102 then invoked design studio 206 to display a representation 662 of garment 114, as shown in FIG. 6C, based on pattern data 134 and the captured fabric. Advantageously, user 104 immediately sees how garment 114 would look when made from the captured fabric. As described above, social manager 312 allows user 104 to share representation 662 with other people, should their opinions be sought for example.

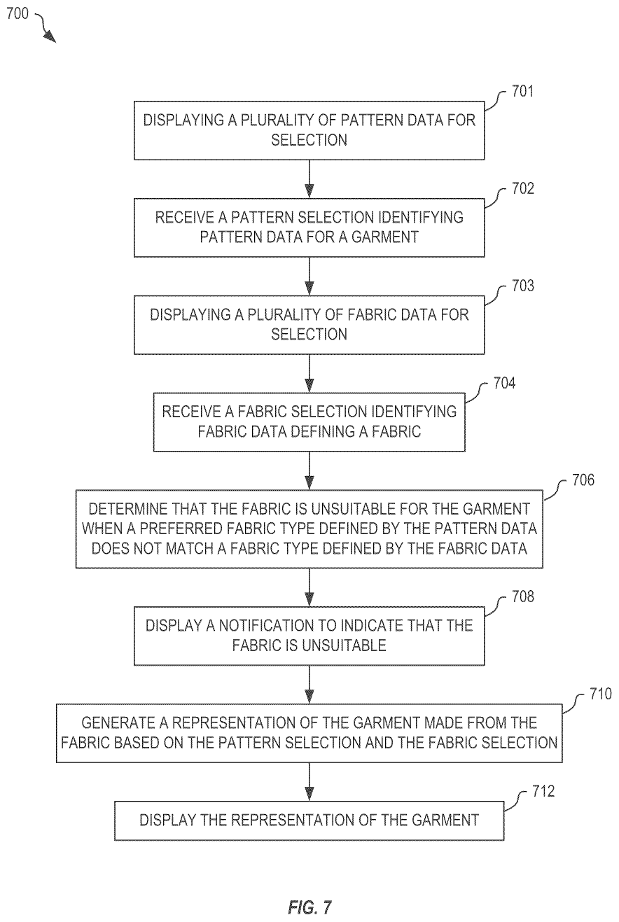

FIG. 7 is a flowchart illustrating one example fashion design assistant method 700. Method 700 is implemented by fashion design assistant tool 102 of FIG. 1 for example.

In block 701, method 700 displays a plurality of pattern data for selection. In one example of block 701, design studio 206 displays pattern data 134 from at least one pattern supplier 140 on screen 110 of client device 106.

In block 702, method 700 receives a pattern selection identifying pattern data for a garment. In one example of block 702, design studio 206 receive an input from user 104 identifying pattern data 134.

In block 703, method 700 displays a plurality of fabric data for selection. In one example of block 703, design studio 206 displays fabric data 136 from at least one fabric supplier 150 on screen 110 of client device 106.

In block 704, method 700 receives a fabric selection identifying fabric data defining a fabric. In one example of block 704, design studio 206 receive an input from user 104 identifying fabric data 136.

Blocks 706 and 708 are optional. If included, in block 706, method 700 determines that the fabric is unsuitable for the garment when a preferred fabric type defined by the pattern data does not match a fabric type defined by the fabric data. In one example of block 706, design studio 206 determines when fabric data 136, paired with pattern data 134 in design 108, is unsuitable. If included, in block 708, method 700 displays a notification on the client device to indicate that the fabric is unsuitable not the preferred fabric type. In one example of block 708, design studio 206 displays notification 112 to advise user 104 that the fabric defined by fabric data 136 is unsuitable for use with the pattern defined by pattern data 134.

In block 710, method 700 generates, based on the pattern selection and the fabric selection, a representation of the garment made from the fabric. In one example of block 710, fashion design assistant tool 102 graphically processes an image from pattern data 134 and an image from fabric data 136 to generate design representation 109.

In block 712, method 700 displays the representation of the garment on a display of the client device. In one example of block 712, fashion design assistant tool 102 displays design representation 109 on screen 110 of client device 106.

Blocks 701-712 may occur in a different order, be repeated, and/or be omitted without departing from the scope hereof.

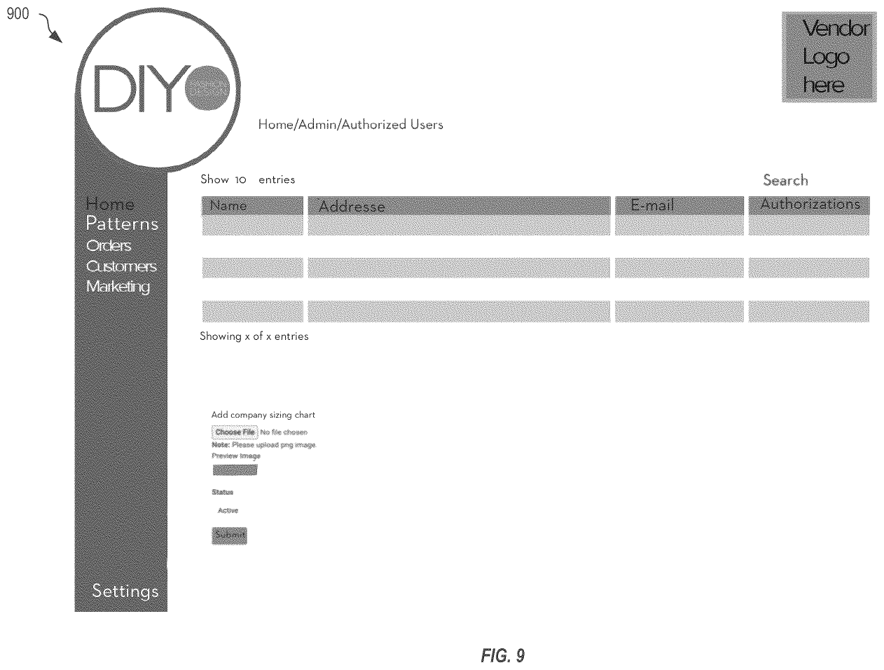

FIG. 9 is a screenshot 900 of pattern interface 232 of server 130 of FIGS. 1 and 2, illustrating set up of fashion design system 100 for multi-vendor use, in embodiments. When a vendor (e.g., pattern supplier 140) signs up for access to system 100, the vendor has use of fashion design assistant tool 102, under the umbrella of DIY Fashion Design's management for example.

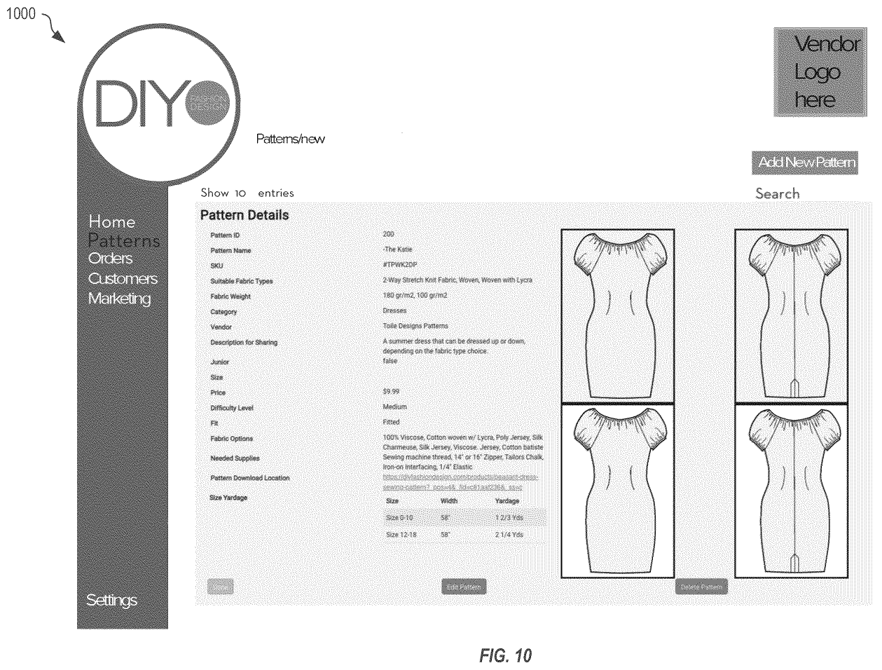

FIG. 10 is a screenshot 1000 of pattern interface 232 of server 130 of FIGS. 1 and 2, illustrating step-by-step pattern-uploading implemented by fashion design system 100 that allows any pattern supplier 140 to easily upload pattern data 134 for use by system 100, in embodiments.

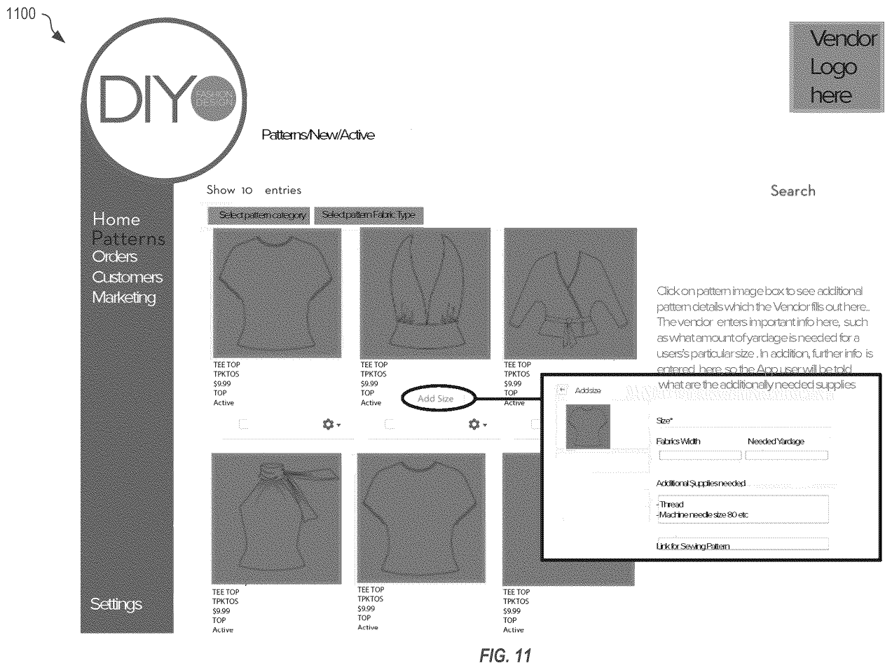

FIG. 11 is a screenshot 1100 of pattern interface 232 of server 130 of FIGS. 1 and 2, illustrating pattern supplier 140 being prompted to provide important sewing pattern information for pattern data 134, for use by fashion design assistant tool 102, in embodiments. When pattern supplier 140 provides this information into the pattern detail section for pattern data 134, it eliminates any need for knowledgeable sales help when user 104 is purchasing materials in a fabric shop with the app. For example, pattern supplier 140 may provide information such as how much fabric is needed according to size for pattern data 134.

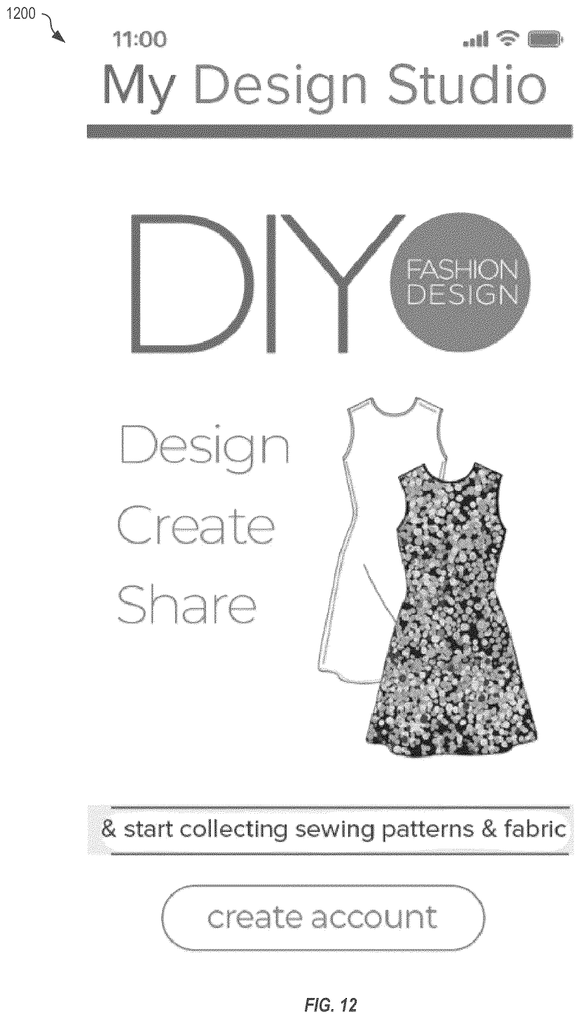

FIG. 12 is a screenshot 1200 of fashion design assistant tool 102 of FIG. 1, inviting a novice DIY sewer to create an account to be able to save, collect, and see a design they may make by combining sewing patterns and fabrics in their personal virtual design studio (e.g., design studio 206 of FIG. 2), in embodiments.

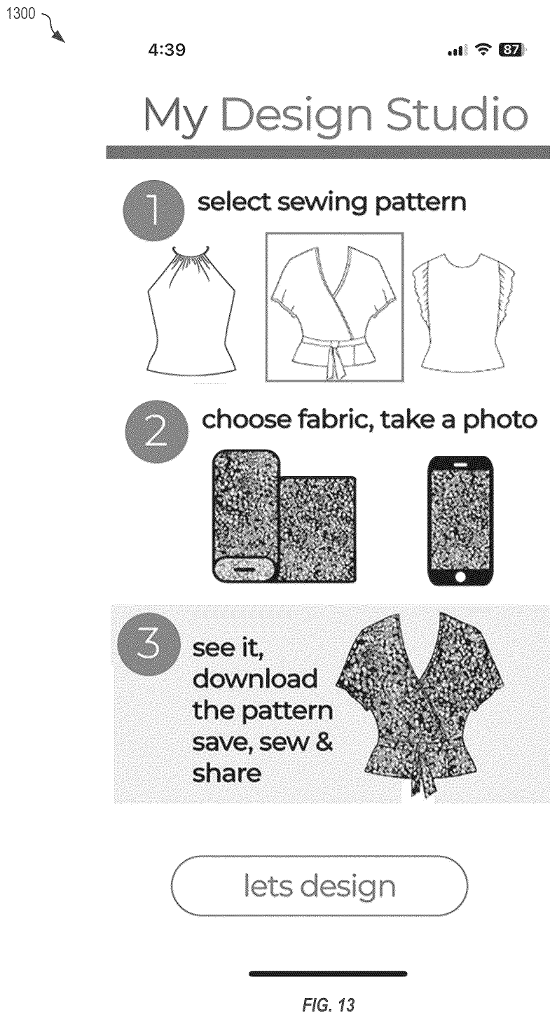

FIG. 13 is a screenshot 1300 illustrating how fashion design assistant tool 102 of FIG. 1 provides a visual of the user's design when they combine a sewing pattern with a fabric, in embodiments.

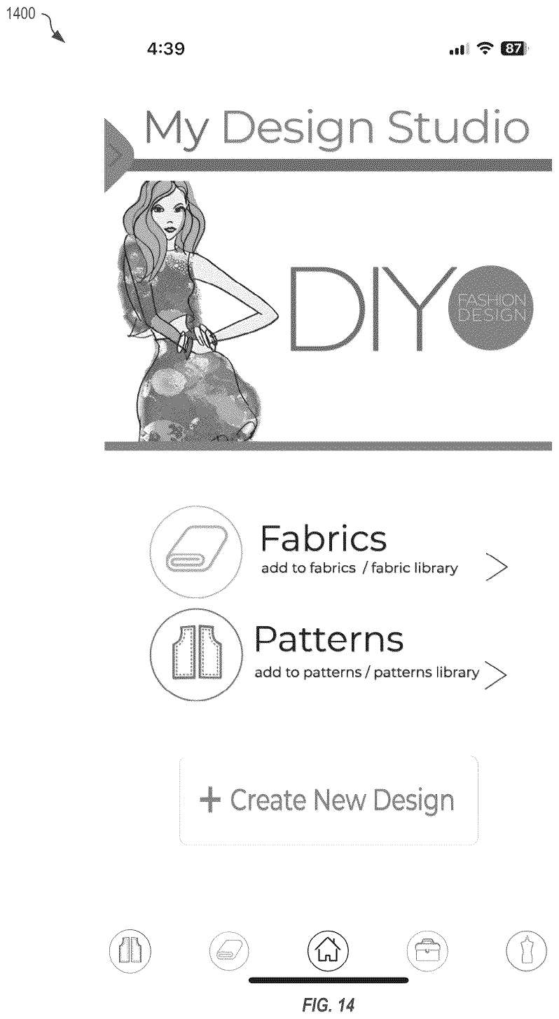

FIG. 14 is a screenshot 1400 illustrating how fashion design assistant tool 102 of FIG. 1 allows user 104 to collect and save fabrics and patterns, which may be updated at any time by user 104, in embodiments.

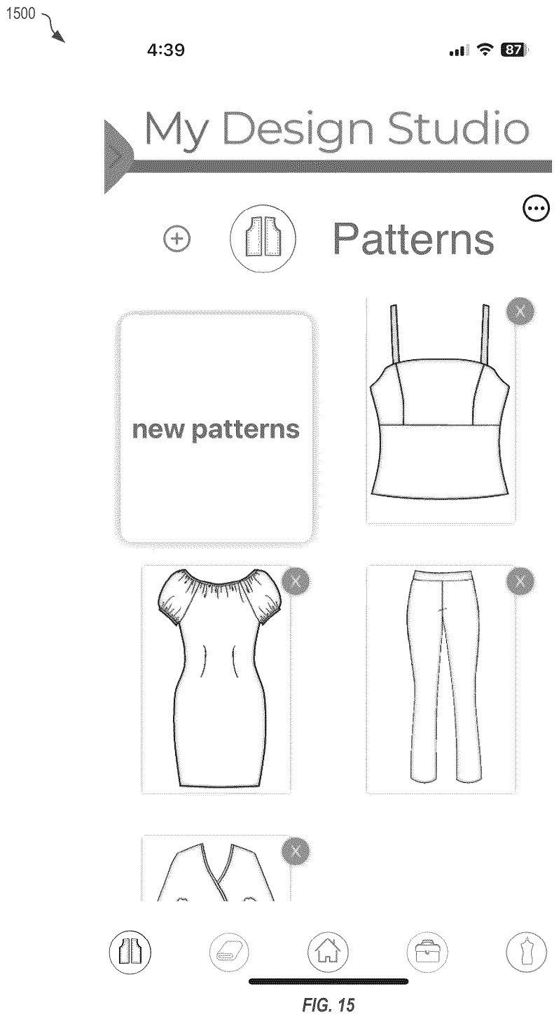

FIG. 15 is a screenshot 1500 illustrating how fashion design assistant tool 102 of FIG. 1 allows user 104 to access to a variety of sewing patterns, in embodiments. A first pattern supplier 140 is for example “Toile Sewing Patterns,” but user 104 will soon have access to a variety of pattern data 134 from many different pattern suppliers 140. User 104 may save and collect sewing patterns in their personal design studio (e.g., design studio 206 of FIG. 2) where they'll have access to their sewing patterns at all times. Each sewing pattern (e.g., pattern data 134) has all information provided by pattern supplier 140 (see FIG. 11). Information may include a type of fabric suitable for this pattern as well as fabric kind suggestions, and a list of supplies needed to finish this garment.

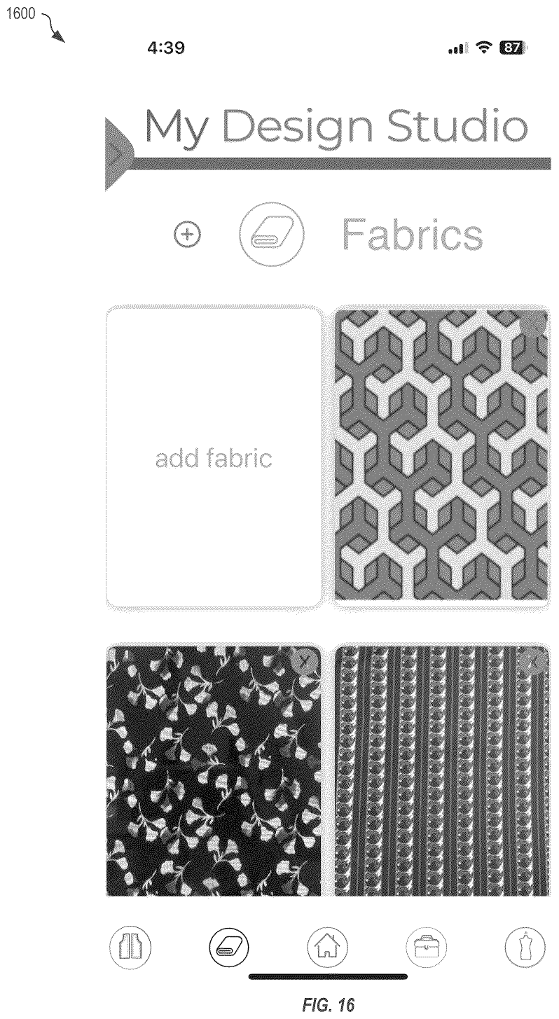

FIG. 16 is a screenshot 1600 illustrating how fashion design assistant tool 102 of FIG. 1 allows user 104 to take a picture, or select one from their photo gallery, to save in this section of fashion design assistant tool 102, in embodiments. User 104 is prompted to enter details about the captured fabric, such as a type of fabric, which is important when choosing a sewing pattern. User 104 is also prompted to provide additional information on the fabric, such as width, washing care, and so on.

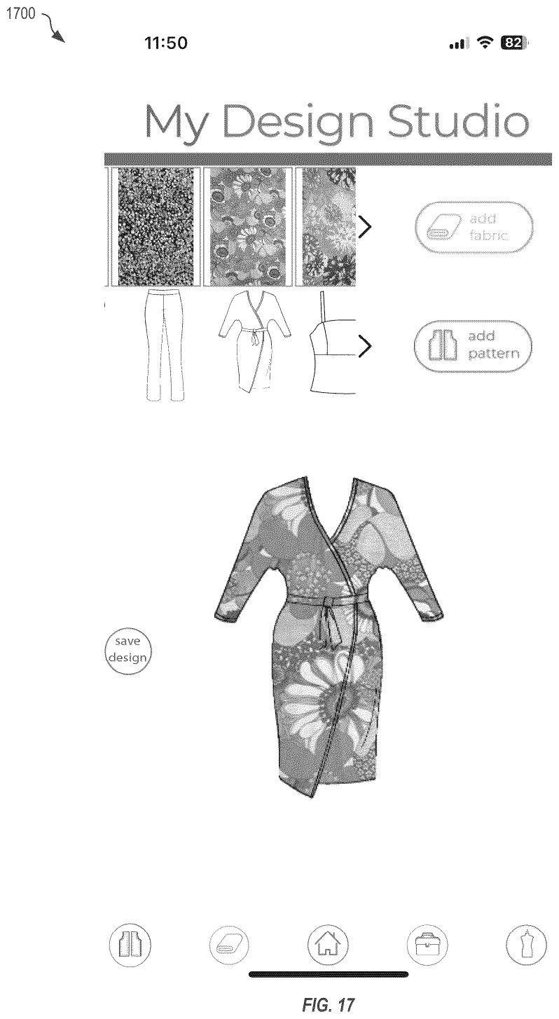

FIG. 17 is a screenshot 1700 illustrating how fashion design assistant tool 102 of FIG. 1 integrates all elements of a design together to provide a visual of a finished garment based on pattern data 134 and fabric data 136 selected by user 104. Advantageously, fashion design assistant tool 102 provides user 104 with a visual (e.g., representation 662 of FIG. 6C) that currently is not available to fabric buyers. For example, screenshot 1700 shows collected fabrics on top and collected sewing patterns below that are interactable, where fashion design assistant tool 102 provides user 104 with prompts when a fabric and pattern are not suitable. Plus, most importantly, user 104 learns instantly from fashion design assistant tool 102 whether the chosen fabric is suitable to be combined with the selected sewing pattern, based upon prompts entered on by pattern supplier 140 (see FIG. 11). Once user 104 has all the needed info to create their design, fashion design assistant tool 102 allows user 104 to purchase the selected sewing pattern and provides information that user 104 needs to know regarding how much fabric is needed according to their size, and fashion design assistant tool 102 also indicates what other supplies are needed to complete the manufacture of the garment.

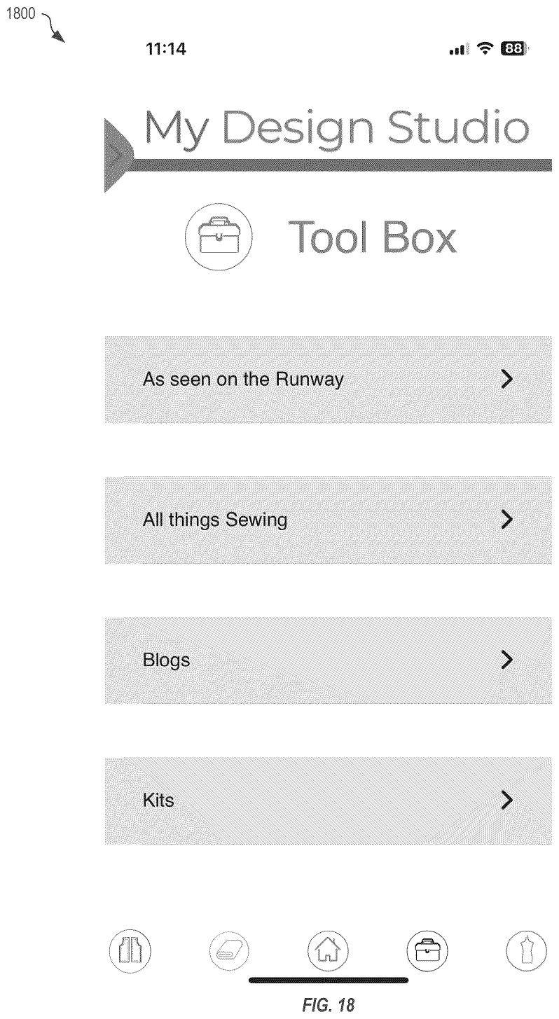

FIG. 18 is a screenshot 1800 illustrating how fashion design assistant tool 102 of FIG. 1 provides a community minded space where user 104 has access to useful information, in embodiments. For example, fashion design assistant tool 102 provides links to sewing tutorials, blogs, trend reports, fabric+pattern kits, and provides a place where user 104 may showcase their designs.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A fashion design assistant method, comprising:
receiving, at a client device, a pattern selection identifying pattern data for a garment;
receiving, at the client device, a fabric selection identifying fabric data for a fabric;
generating, based on the pattern selection and the fabric selection, a representation of the garment made from the fabric; and
displaying the representation of the garment on a display of the client device.

2. The fashion design assistant method of claim 1, the generating comprising graphically processing a first image defined within the pattern data and a second image defined within the fabric data to generate the representation of the garment.

3. The fashion design assistant method of claim 1, further comprising:
determining that the fabric is unsuitable for the garment when a preferred fabric type defined by the pattern data does not match a fabric type defined by the fabric data; and
displaying a notification on the client device to indicate that the fabric is unsuitable.

4. The fashion design assistant method of claim 1, further comprising displaying, at the client device, a plurality of selectable pattern data.

5. The fashion design assistant method of claim 4, further comprising interacting, via the client device, with a pattern supplier corresponding to the pattern selection to facilitate purchase of the pattern data.

6. The fashion design assistant method of claim 1, further comprising displaying, at the client device, a plurality of selectable fabric data.

7. The fashion design assistant method of claim 6, further comprising interacting, via the client device, with a fabric supplier corresponding to the fabric selection to facilitate purchase of the fabric.

8. A non-transitory computer-readable medium containing machine-readable instructions for causing a computer to:
receive, at a client device, a pattern selection identifying pattern data for a garment;
receive, at the client device, a fabric selection identifying fabric data for a fabric;
generate, based on the pattern selection and the fabric selection, a representation of the garment made from the fabric; and
display the representation of the garment on a display of the client device.

9. The non-transitory computer-readable medium of claim 8, further comprising machine-readable instructions for causing the computer to graphically process a first image defined within the pattern data and a second image defined within the fabric data to generate the representation of the garment.

10. The non-transitory computer-readable medium of claim 8, further comprising machine-readable instructions for causing the computer to:
determine that the fabric is unsuitable for the garment when a preferred fabric type defined by the pattern data does not match a fabric type defined by the fabric data; and
display a notification on the client device to indicate that the fabric is unsuitable.

11. The non-transitory computer-readable medium of claim 8, further comprising machine-readable instructions for causing the computer to display, at the client device, a plurality of selectable pattern data.

12. The non-transitory computer-readable medium of claim 11, further comprising machine-readable instructions for causing the computer to interact, via the client device, with a pattern supplier corresponding to the pattern selection to facilitate purchase of the pattern data.

13. The non-transitory computer-readable medium of claim 8, further comprising machine-readable instructions for causing the computer to display, at the client device, a plurality of selectable fabric data.

14. The non-transitory computer-readable medium of claim 13, further comprising machine-readable instructions for causing the computer to interact, via the client device, with a fabric supplier corresponding to the fabric selection to facilitate purchase of the fabric.

15. A fashion design system, comprising:
a computer server, having:
a pattern interface comprising machine-readable instructions stored on non-transitory computer-readable medium that, when executed by a first processor of the computer server, causes the computer server to interact with a pattern supplier to receive pattern data;
a fabric interface comprising machine-readable instructions stored on the non-transitory computer-readable medium that, when executed by the first processor of the computer server, causes the computer server to interact with a fabric supplier to receive fabric data; and
a database for storing the pattern data and the fabric data; and
a fashion design assistant tool comprising machine-readable instructions stored on non-transitory computer-readable medium that, when executed by a second processor of a client device, cause the client device to:
receive a pattern selection identifying the pattern data for a garment;
receive a fabric selection identifying the fabric data for a fabric;
generate, based on the pattern selection and the fabric selection, a representation of the garment made from the fabric; and
display the representation of the garment on a display of the client device.

16. The fashion design system of claim 15, the fashion design assistant tool further comprising machine-readable instructions stored on the non-transitory computer-readable medium that, when executed by the second processor, cause the client device to store the pattern selection and the fabric selection in the database as a design.

17. The fashion design system of claim 15, the fashion design assistant tool further comprising machine-readable instructions stored on the non-transitory computer-readable medium that, when executed by the second processor, cause the client device to interact with the pattern supplier to purchase the pattern data.

18. The fashion design system of claim 15, the fashion design assistant tool further comprising machine-readable instructions stored on the non-transitory computer-readable medium that, when executed by the second processor, cause the client device to interact with the fabric supplier to purchase the fabric.
